(19) United States
(12) Patent Application Publication
(10) Pub. No.: US 2018/0268037 A1
(43) Pub. Date: Sep. 20, 2018

(54) SYSTEM FOR AND METHOD OF ESTIMATING THE CHEMICAL COMPOSITION OF AN ARTICLE

(71) Applicant: Granta Design Limited, Cambridge (GB)

(72) Inventors: David Cebon, Cambridge (GB); William Martin, Cambridge (GB)

(73) Assignee: Granta Design Limited, Cambridge (GB)

(21) Appl. No.: 15/920,685

(22) Filed: Mar. 14, 2018

Related U.S. Application Data
(63) Continuation of application No. 14/241,269, filed on Jul. 28, 2014, now abandoned.

(30) Foreign Application Priority Data
Sep. 6, 2011 (GB) 1115353.3

(51) Int. Cl. G06F 17/30; G06Q 10/10

(52) U.S. Cl. CPC G06F 17/30554; G06Q 10/10; G06F 17/30536

(57) ABSTRACT

A system for indicating the presence of a substance in an article, wherein the article comprises at least one component, comprises: means for selecting a substance; a component data unit for providing component data wherein the component data comprises at least one material comprised in each component; a primary material records unit for providing a plurality of primary material records; a secondary material records unit for providing a plurality of secondary material records; a substance record unit for providing a plurality of substance records associated with a material, wherein each substance record contains percentages of substances contained in the associated material; and a processor configured to: select material records of the at least one material from the primary material records unit if the at least one material is present in the primary material records; select material records corresponding to the at least one material from the secondary material records unit if no substance records associated with the at least one material are present in the substance record unit; calculate the total amount of the selected substance present in the article based on the component data, selected material records, and substance records, and provide an indication of the total amount of the selected substance.

### CROSS-REFERENCE TO RELATED APPLICATIONS

The present application is a continuation of U.S. application Ser. No. 14/241,269, filed Jul. 28, 2014, which is a National Phase entry under 35 U.S.C. § 371 of International Application No. PCT/GB2012/052181, filed Sep. 6, 2012, published in English, which claims priority from Great Britain application No. GB 1115353.3, filed Sep. 6, 2011, the disclosures of which are incorporated herein by reference.

### TECHNICAL FIELD

The present invention generally relates to a system for and a related method of determining the chemical composition of an article.

### BACKGROUND OF THE INVENTION

Determining the composition of a product or article post-manufacturing is an important safety requirement in view of the potentially harmful substances that the article may contain. Articles range widely in complexity, including for example, kitchen utensils, toys, electronics, furniture, motor vehicles and aeroplanes. Some of these articles may contain substances which are classed as potentially harmful during their manufacture and, in some cases, after their release on the market. The ability to accurately and quickly identify the presence of such substances in the articles in order to stop further production and/or supply is paramount to manufacturers and importers worldwide.

Furthermore, at present, there are a number of related legal requirements applying to manufacturers and suppliers worldwide. In Europe, for example, there are reporting obligations under the European Community Regulation on chemicals (REACH Regulation). Specifically, Article 33 of this Regulation requires suppliers and manufacturers of articles containing any substance classed as ‘Substance of Very High Concern’ (SVHC) under REACH to provide consumers with sufficient information for safe use of any supplied article which contains a SVHC in a concentration above 0.1% weight by weight (w/w). Under this regulation, the suppliers/manufacturers must respond to consumer request within 45 days at no cost to the customer.

It is currently possible to determine the chemical composition of an article made of various parts by obtaining the relevant information from the suppliers of its parts. For example, some industries in Europe (notably electronics and automotive), have developed infrastructure to gather substance composition information from their supply chain. However, manufacturing supply chains are often highly complex and global. For example, complex systems such as aeroplanes are comprised of a variety of sub-assembly components, e.g. standard components such as O rings and fasteners, landing gear, wiring harnesses etc, each of which may be obtained via multiple tier supply chains. Determining the substance composition is required not only for aircraft itself, but also for any spare parts, monitoring equipment and maintenance equipment that are sold to customers.

The main challenge for manufacturers is that it is difficult to track back through the various tiers of supply chains to determine the composition of articles. Furthermore, there may be missing actors in the supply chain, or actors that have no legal obligation to provide their customers with such information. In many cases, an article may have been manufactured many years in the past, making it practically impossible to identify the suppliers involved and request substance composition. This may result in inaccurate estimations of substance composition.

Slow and/or inaccurate determinations of substance composition are dangerous for consumers that may remain unaware of potentially harmful substances present in a product. Furthermore, they may pose a significant risk that legal requirements are not complied with by manufacturers and/or suppliers.

The present invention seeks to overcome the problems associated with existing reporting systems.

### SUMMARY OF THE INVENTION

The present invention provides a system for indicating the presence of a substance in an article, wherein the article comprises at least one component, the system comprising:
means for selecting a substance;
a component data unit for providing component data wherein the component data comprises at least one material comprised in each component;
a primary material records unit for providing a plurality of primary material records;
a secondary material records unit for providing a plurality of secondary material records;
a substance record unit for providing a plurality of substance records associated with a material, wherein each substance record contains percentages of substances contained in the associated material; and
a processor configured to:
   select material records of the at least one material from the primary material records unit if the at least one material is present in the primary material records;
   select material records corresponding to the at least one material from the secondary material records unit if no substance records associated with the at least one material are present in the substance record unit;
   calculate the total amount of the selected substance present in the article based on the component data, selected material records, and substance records, and
   provide an indication of the total amount of the selected substance.

The present invention also provides a method for indicating the presence of a substance in an article, wherein the article comprises at least one component, the method comprising the steps of:
selecting a substance;
providing component data, wherein the component data comprises at least one material comprised in each component;
providing a plurality of primary material records; providing a plurality of secondary material records;
providing a plurality of substance records, wherein each substance record contains the percentage of at least one substance contained in a material;
   selecting material records of the at least one material if the at least one material is present in the primary material records;
   selecting material records corresponding to the at least one material if information about the substance contents of the primary material records is not present;
   calculating the total amount of the selected substance present in the article based on the component data, selected material records, and substance records, and
   providing an indication of the total amount of the selected substance.

The system in accordance with the present invention provides an efficient solution for determining the composition of an article, representing a safer, quicker and lower cost alternative to existing systems. Given the complexity of the supply chains, their associated databases and relative frequency of changes to the lists of harmful substances, the present system is also easier to maintain.

A key feature of the system is that, wherever possible, it uses the results of desktop research for typical uses of substances. The system may only use specific substance data (such as declaration data provided for example by suppliers of articles, components, materials and preparations), when the quantity of a substance is likely to exceed the allowable threshold concentration for a particular application.

The component data of an article may be one of the following:
i) ‘In-house sub assembly (i.e. designed by in-house designers of an article).
ii) Supplier sub assembly (i.e. the entire sub assembly is procured from a supplier) wherein neither the material nor the substance content of the article are not known. While prior art methods require a user to ask the supplier to declare the substance content of the sub assembly, the present invention uses the supplier material content of the sub assembly which may be declared by a supplier (e.g. the article is made from plasticized PVC), rather than the substance content (e.g. the part contains 10% of a particular plasticizing agent). The present invention also uses ‘fallback links’ if needed so that it can still estimate the substance content using the secondary (MU) records if the precise substance content of the specific Material is unknown. The use of ‘fall-back links’ to alternative sources of data leads to a more robust solution, which avoids system failure.
iii) Standard Industry Components including items such as bolts that have standard industry part numbers. One needs to translate these part numbers into a generic part (using an ID translation tool as shown in FIG. 4) so that one can estimate the substance content from the ‘where used’ data for the generic component record.

### BRIEF DESCRIPTION OF THE DRAWINGS

Specific examples of the invention will now be described in greater detail with reference to the following figures in which

FIG. 1 schematically represents a system in accordance with the present invention;

FIG. 2a schematically represents a specific situation when information is available to connect a material to the substances it contains. This information is typically made available by a declaration from the material supplier.

FIG. 2b schematically represents an example of one aspect of the present invention, wherein a ‘fallback link’ is used to connect a specific data record with a data record in the Material Universe, in a case where the supplier declaration information in FIG. 2a is not available;

FIG. 3 schematically represents a method in accordance with the present invention;

FIG. 4 shows an Identifier (ID) Translation tool used to correlate recognised standard industry part numbers to generic component records;

FIG. 5 is a table listing the variables used in calculating a return on investment (RoI);

FIG. 6 is a graph showing an estimated customer RoI for five years; and

FIG. 7 is a graph showing an estimated supplier RoI for five years.

### DETAILED DESCRIPTION OF THE INVENTION

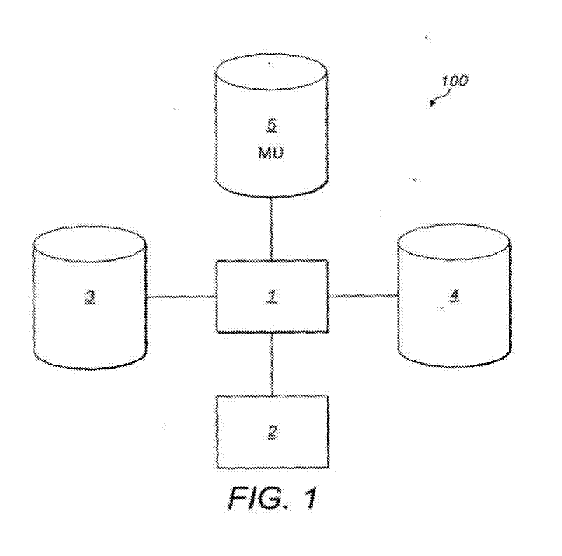

FIG. 1 shows components of a system 100 for indicating the presence of a substance in an article according to the present invention. The system 100 comprises a processor 1 connected to a user interface 2. The connection may be wired or wireless and the user interface 2 may be a personal computer, tablet or smart phone, for example. The processor 1 is coupled to a component data unit 3 which may store information on materials making up a component or sub-assembly.

The processor 1 is also coupled to a substance data unit 4 which stores any available substance data such as declaration for an article which may be obtained from a supplier, for example, or other data source. The materials or component records in the component data unit 3 may be associated with substance data such as declaration data if this is available in the substance record or data unit 4.

The processor 1 is further coupled with a generic material record unit 5 which stores generic material records. The present inventors have developed such generic records (referred hereafter as a ‘Materials Universe’, MU 5) for over 3000 bulk engineering materials, ranging from metal alloys to plastics, rubbers, adhesives and ceramics. The MU 5 may store the value of a maximum percentage of a candidate substance which may be found in a particular material. Furthermore, the MU 5 may store information for substances of interest, also referred to as selected, or candidate substances. For example, the list of candidate substances present in the MU 5 developed by the present inventors mirrors the Candidate List of SVHCs under REACH in Europe. For example, a record for plasticised PVC in the MU 5 may include a plasticiser DEHP at a maximum concentration of 40%.

The MU 5 developed by the present inventors is included in a material data management product, MI, that stores and manages large datasets of materials for engineering enterprises. Separate from the MU 5, the materials or component records in the component data unit 3 are included in the MI. For example, the MI may comprise tables including the materials or component records in the component data unit 3.

The MU 5 may be used to create a list of parts, hereafter referred to as a ‘Bill of Materials’ (BoM) for a sub component or sub assembly of a parent assembly (article) to be assessed. The BoM could be created via the user interface 2 by an engine manufacturer or sub assembly supplier, for example, who is able to select records from the MU 5. In the case of an article such as an engine, a BoM may include, for example, all engine sub assemblies produced in house or sub assemblies and/or components for any supplied sub assemblies.

In addition to selecting generic material records from the MU 5 to describe their BoM, users can also select materials or component records from the component data unit 3. The component records in the component data unit 3 may be associated with substance data such as declaration data if this is available in the substance data unit 4.

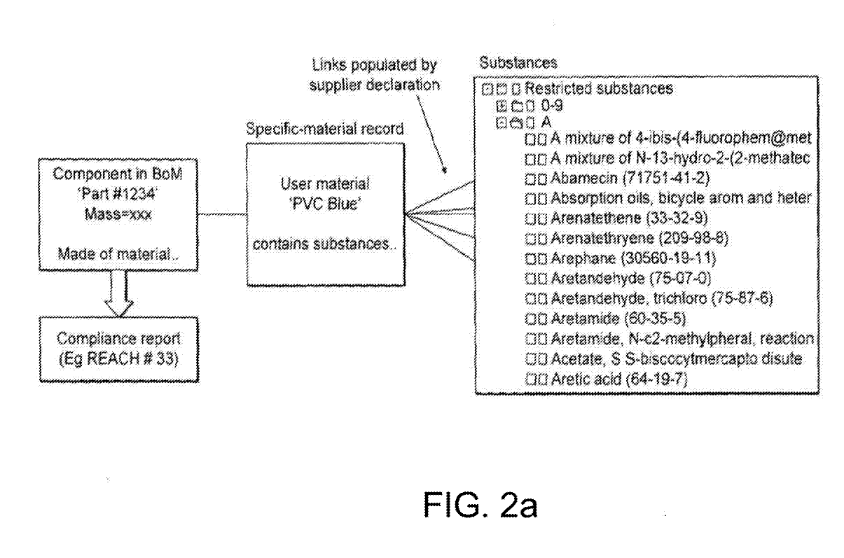

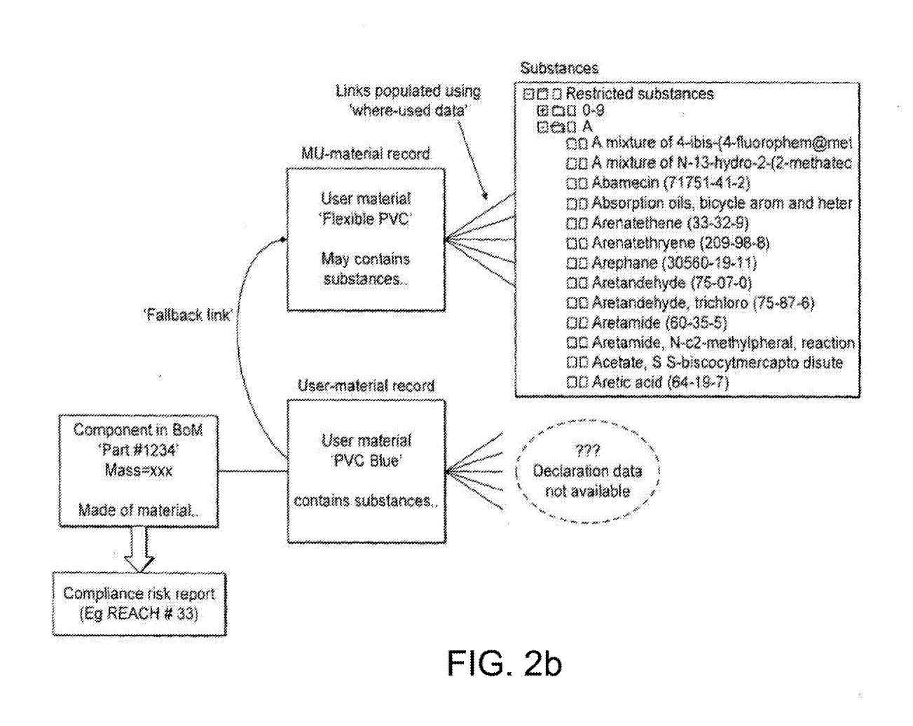

In instances where a generic material record from the component data unit 3 has been selected in the BoM Generator tool, but there is no associated substance data available from the substance data unit 4, the system obtains the missing data from the MU 5. For example, the MU 5 may store the maximum percentage of a candidate substance which may be found in a particular material from the MU 5. This system's functionality is referred to as a ‘Fall Back Link’ to obtain missing substance data from a relevant generic record in the MU 5. An example of such an instance is shown in FIGS. 2a and 2b.

The processor 1 is configured to calculate and provide an indication of the total amount of a candidate substance present in an article, as will be described in detail below. The user interface 2 is configured to display an indication of the total amount of a candidate substance present in an article. Alternatively, the processor 1 may be configured to generate a report comprising the total amount for one or more candidate substances present in an article as will be described below.

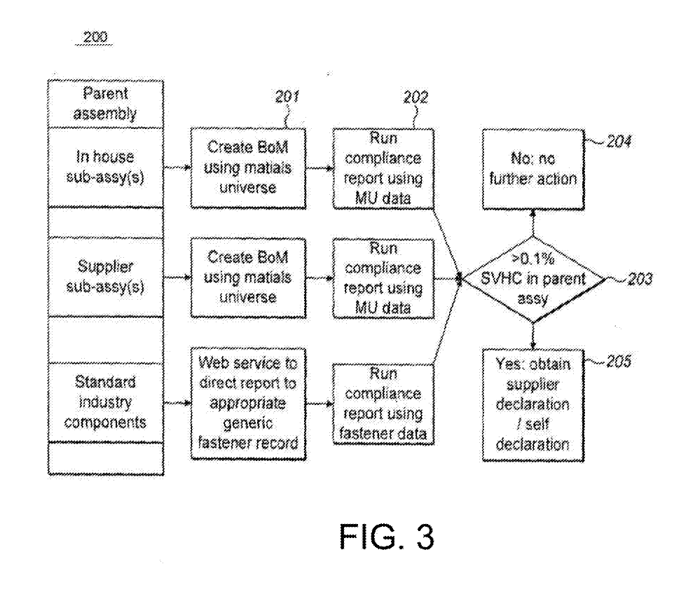

FIG. 3 illustrates a method 200 for indicating the presence of a substance in an article in accordance with the present invention. An article such as a parent assembly of a manufacturer, e.g. an engine, may be comprised of three broad categories of sub components or sub assemblies, hereafter referred to as components:

1. ‘In house’ sub components and/or sub assemblies that are designed and manufactured by a manufacturer, such as, for example, a machined gearbox assembly.

2. ‘Supplier Sub Assy’ representing sub components or sub assemblies that are manufactured by a supplier. Such parts are also known as Source controlled or Commercial Off-The-Shelf (COTS) parts, such as, for example, ECU or wiring harnesses.

3. ‘Standard Industry Components such as fasteners, (nuts, bolts, washers), O Rings, belts, or cable ties. These are typically described by an industry standard part number and are often defined by industry standard specifications. There are many other types of industry standard components and the method in accordance with the present invention applies to these as well.

For components of types 1 and 2 defined above, the method comprises broadly similar steps:

Step 201:

A Bill of Materials BoM is generated for a component to be assessed. The BoM could be generated via the user interface 2 by an engine manufacturer or sub assembly supplier, for example, who may select, for each component, generic material records from the MU 5.

The present inventors have developed a BoM Generator spreadsheet, which is a customised Excel tool created enabling a BoM to be manually created by selecting material records from the MU 5. As an alternative to using the BoM Generator, a user may customise a BoM extract from a PLM system to match the XML BoM schema that can be read by a reporting system of Processor 1.

In addition to selecting generic material records in the BoM Generator for each component, users can also select materials or component records from the component data unit 3. The component records in the component data unit 3 may be associated with substance data such as declaration data if this is available in the substance data unit 4.

Accordingly, a BoM may comprise:
component data, which may include at least one component present in an article, which may be selected by the system from component data unit 3 or inputted by the user via the user interface 2,
material data associated with the component data, representing at least one material comprised in the at least one component (the material data being obtained from the component data unit 3 or from generic records of the MU 5); and
weight data representing the percentage of at least one substance present in a component having an associated record in the substance data unit 5 (where this exists), or a maximum percentage of a substance contained in a material, obtained from the MU 5.

Step 202:

A substance may be selected, referred to as a candidate substance. The candidate substance may be selected from the MU 5 or by input of a user via the user interface 2.

Next, the processor 1 may calculate the amount of the selected substance present in each component, based on the data present in the BoM. The process may be repeated for one or more candidate substances of interest.

The total amount of a selected substance in each component (i.e. sub-assembly) may be indicated or displayed for example to the user interface 2. Alternatively, the system may comprise a report generator for generating for example a compliance report. A predefined compliance report definition may be coded into reporting software available to the processor. For example, a XML BoM file may be used to generate the report. A suitable algorithm may be used to calculate the percentage of a candidate substance present in each component or material present in an article. If there are any candidate substance data present in the article, and their weight by weight percentage in the article exceeds a predetermined value (e.g. 0.1%) across the article, the processor 1 may indicate information only for these candidate substances.

If there are no candidate substances exceeding the predetermined value, no further action is necessary, for example when the candidate substance data in the MU 5 is updated with a new candidate substance a different candidate substance data is inputted by via the user via the user interface 2. When this occurs, the system updates the MU 5 with new associations of substances to MU materials and maximum % data reflecting the changes to the candidate substance data. The system may re-calculate the total amount of the new candidate substance in the article and a new report may be optionally generated.

Step 203:

The system may assess if the possible weight of a selected substance could exceed a predetermined threshold across the article (i.e. parent assembly). For example, a component such as in house bracket assembly weighing 20 g may have a possible content of 1% candidate substance, such as DEHP. Accordingly, the candidate substance present in the parent assembly could not exceed a 0.1% threshold if the parent assembly is an engine weighing 200 kg.

If the system determines that the total amount of a candidate substance in the article could exceed a predetermined threshold. An indication may be made to the user, for example via the user interface 2. In this scenario, a user may, for example, obtain a declaration from a supplier of the component or material included in the article (Step 205). The system 100 may generate a report including the article components containing candidate substances above a predetermined threshold and the percentage in which they may be contained across the article. If a declaration is obtained, the declaration information may be stored in the relevant material or component data record in component data unit 3. The XML BoM file will be updated to reference this specific record, rather than the generic MU record. The system can then determine if the amount of candidate substance still exceeds the predetermined threshold across the article taking into consideration the new declaration data.

For component type 3, Standard Industry Components (hereafter referred to as SIC), the method includes the following steps:

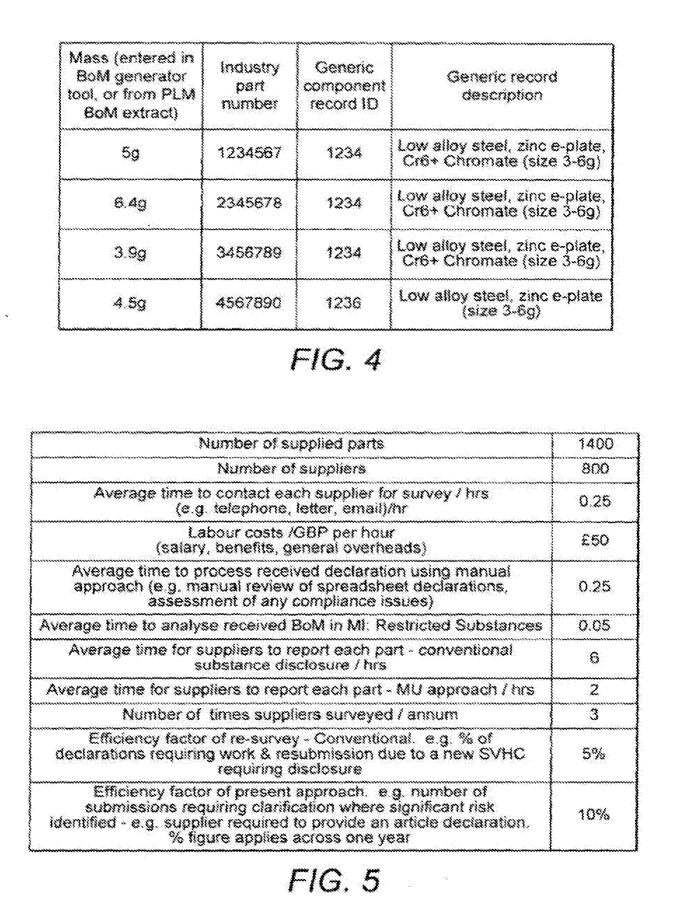

A component of type 3 may be inputted by a user via the user interface 2 into a BoM Generator for example. The processor 1 may use a translating component such as an ‘ID Translation tool’ shown in FIG. 4, used to associate recognised standard industry part numbers with generic component records present in the MU 5.

By taking this approach, a large number of SIC part numbers can be described by a limited set of generic records in the MU 5, comprising the approximate % substance composition of a fastener.

For metal plated fasteners for example, the chemical composition is known and available in the MU 5. Therefore there is no the need for substance data in the substance data unit 4. For fasteners that are manufactured from materials with flexible formulations such as rubbers and plastics, restricted substance content can be expressed in the MU 5 only as an expression of risk rather than a precise association. For example, an EPDM O Ring may contain the plasticiser DOP up to 20%. If the system indicates that for a component in this latter category there is risk that its candidate substance content could exceed 0.1% across the article (assembly) in which it is used, a declaration can be obtained from the supplier of the fastener, and the relevant information stored in the substance data unit 4. The system can then be used to indicate the presence of the candidate substance in the article, based on the updated substance data.

The key advantage of this approach is that it enables fast and effective use of resources, increasing safety for consumers and reducing the cost of compliance and risk assessment activities.

Rather than requesting declarations from all suppliers of all production materials present in an article and from all suppliers of bought-in articles and SICs every time a candidate substance list is updated, for the majority of cases such calculations need only be carried out once. The system may generate reports based on newly researched data in the MU 5.

Producing a BoM from a list of existing materials, such as using materials record unit data from the MU 5, is much simpler and faster than obtaining substance data from a substance data unit 4, for example by obtaining a substance declaration. Making a substance declaration would require a system wherein a BoM is replaced by a Bill of Substances. Most organisations do not have efficient procedures or data sources to support this capability and thus this would represent a very time consuming and difficult process.

Furthermore, in instances where a declaration in required, the present invention enables the precise identity of a candidate substance at risk to devised. This can be then communicated to the suppliers in order to expedite their response.

The following cost saving analysis is based on a comparison of conventional compliance gathering activity against the method in accordance with the invention. A manufacturer in this example is assumed to gather SVHC declarations from 800 suppliers who supply a total of 1400 parts. Based on the assumptions outlined in the table of FIG. 5, the level of effort from the manufacturers' perspective and the suppliers' perspective is assessed.

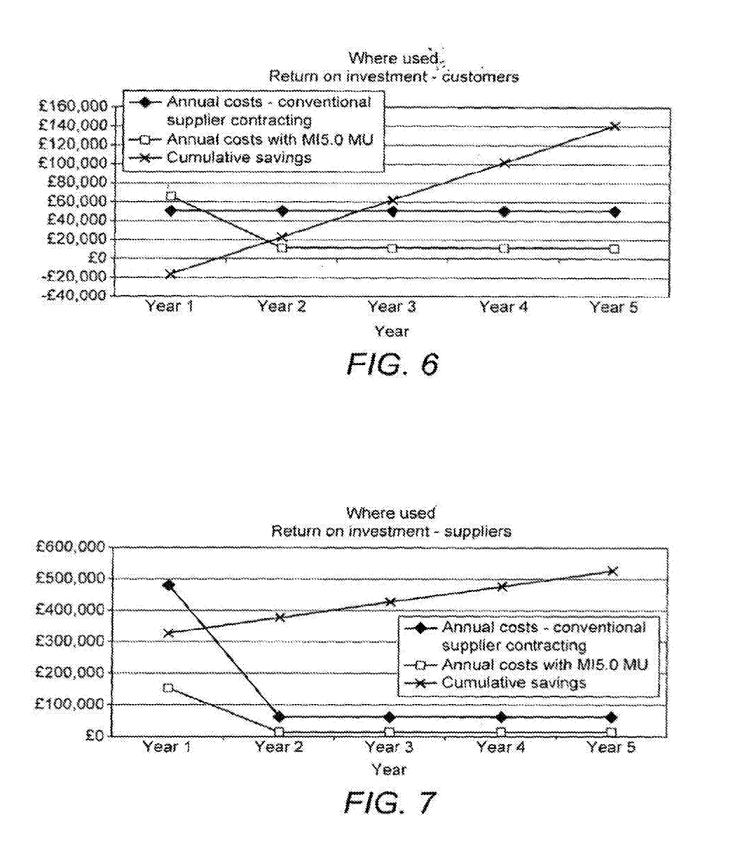

FIG. 6 shows the estimated return on investment (ROI) for customers as a function of time. The graph shows that there is clear advantage to customers using a system in accordance with the present invention vs conventional approaches. In this example, the cost of buying a perpetual license for using a system in accordance with the present invention makes the first year slightly more expensive than the conventional approach in the first year, but this initial investment is quickly recouped from year 2 onwards. The primary reason for this reduced cost is that less suppliers need be contacted and less declarations need be processed. Using a system in accordance with the present invention to process received data also offers a clear efficiency gain over manual manipulation of data.

The RoI from the supplier's perspective shown in FIG. 7 also shows clear efficiency and cost gains. Initially this is because the reporting process is relatively straightforward as they are selecting predefined materials, rather than sourcing actual material composition data which can be an extremely onerous and time consuming process. Whenever the Candidate List is updated, suppliers need only carry out more work if their supplied part (component) is shown to have a risk of containing a candidate substance at a level sufficient to exceed a predetermined threshold of the parent assembly (article) in which it is used.

The present invention has a number of other applications.

First, a system in accordance with the preset invention may be used to indicate the levels of energy, carbon dioxide or other environmental pollutants emitted in manufacture of a component. The use of fall back links to relevant material, process and component records in accordance with the present invention may be applied to indicate such levels. Accordingly, the present invention may be used in environmental audit applications, for example.

Furthermore, the fallback link functionality of the present system may be used for material substitution. For example, the system may be used to indicate the attribute data such as Young's modulus or tensile strength, prior to attempting the material substitution.

Compliance reporting by a system in accordance with the invention could be extended to cover ‘predictive lists’ such as the Substitute It Now (SIN) List. Lists such as this comprise substances that meet the criteria of being an SVHC, but are not yet part of the Candidate List of SVHCs. Extending scope to lists such as this would enable a more proactive approach to SVHC compliance to be taken, increasing the lead time to respond to customer requests for Article 33 reports, and to risk assess product and materials portfolio for potential obsolescence risks and other related business risks such as undocumented reformulation of materials by suppliers.

Other declarable substance lists could be researched and links to MU 5 records to capitalise on the efficiencies to be gained.

1. A system for determining an amount of a substance in an article, comprising at least one component, the system comprising:
at least one processor;
at least one data storage module coupled to the at least one processor, the at least one data storage module storing:
component data including information of at least one material present in the at least one component;
data of primary materials including materials-supplier provided data on amounts of substances contained in each primary material;
data of secondary materials including generic data on amounts of substances contained in each secondary material;
wherein the at least one processor is configured to:
identify, from the component data, the at least one material present in the at least one component;
determining the amount of the substance present in the at least one material if the at least one material is present in the data of primary materials;
if the at least one material is not present in the data of primary materials, determining the amount of the substance present in the at least one material if the at least one material is present in the data of secondary materials;
determine the total amount of the substance present in the article based on the component data, and at least one of the data of primary materials or the data of secondary materials, and
provide an indication of the total amount of the substance present in the article if the total amount exceeds a predetermined level.

2. The system according to any claim 1, further comprising a report generator for generating a report based on the indication provided by the at least one processor.

3. The system according to claim 1, wherein the at least one processor is further configured to receive an query for a primary material and retrieve data on the primary material from the data of primary material.

4. The system according to claim 1, wherein the at least one processor is further configured to receive an query for a secondary material and retrieve data on the secondary material from the data of secondary materials.

5. The system according to claim 1, wherein the component data comprises the weight of each component and wherein the indication is provided in percentage weight by weight.

6. The system according to claim 1, wherein the selected substance is a substance of very high concern.

7. The system according to claim 1, wherein the component data is at least one of in-house sub-assembly data, supplier sub-assembly data or standard component data.

8. The system according to claim 1, wherein the at least one process is further configured to translate the standard component data to estimate an amount of the substance in the at least one material.

9. A method for determining an amount of a substance in an article comprising at least one component, the method comprising:
identifying, by one or more processors, the at least one material from component data in a data storage module accessible by the one or more processors, wherein the component data includes information of at least one material present in the at least one component;
determining, by the one or more processors, an amount of the substance present in the at least one material if the at least one material is present in a data of primary materials in the data storage module, wherein the data of primary materials includes materials-supplier provided data on amounts of substances contained in the each primary material;
if the at least one material is not present in the data of primary materials, determining, by the one or more processors, the amount of the substance present in the at least one material if the at least one material is present in a data of secondary materials in the data storage module, wherein the data of secondary materials includes generic data on amounts of substances contained in the each secondary material;
determining, by the one or more processors, the total amount of the substance present in the article based on the component data, and at least one of the data of primary materials or the data of secondary materials; and
providing an indication of the total amount of the substance if the total amount exceeds a predetermined level.

10. The method according to claim 9, further comprising the step of generating a report based on the indication.

11. The method according to claim 9, wherein search, by one or more processors, the data of primary materials further comprises:
inputting a query for a primary material into the one or more processors to retrieve data on the primary material from the data of primary materials.

12. The method according to claim 9, wherein searching, by one or more processors, the data of secondary materials further comprises:
inputting a query for a secondary material into the one or more processors to retrieve data on the secondary material from the data of secondary materials.

13. The method according to claim 9, wherein the component data comprises the weight of each component and wherein the indication is provided in percentage weight by weight.

14. The method according to claim 9, wherein the substance is a substance of very high concern (SVHC).

15. The method according to claim 9, wherein the component data is at least one of in-house sub-assembly data, supplier sub-assembly data or standard component data.

16. The method according to claim 9, further comprising the step of estimating an amount of the substance in the at least one material from standard component data.
